(19) United States
(12) Patent Application Publication
(10) Pub. No.: US 2004/0087303 A1
(43) Pub. Date: May 6, 2004

(54) System and method for collecting debugging and system crash information from a mobile phone

(75) Inventor: Pierluigi Pugliese, Vaterstetten (DE)

Correspondence Address: HITT GAINES P.C., P.O. BOX 832570, RICHARDSON, TX, 75083, US

(73) Assignee: Agere Systems, Incorporated, Allentown, PA

(21) Appl. No.: 10/693,470

(22) Filed: Oct. 24, 2003

(30) Foreign Application Priority Data
Oct. 25, 2002 (DE) 102 49 700.1

(51) Int. Cl. H04M 3/00; H04Q 7/20

(52) U.S. Cl. 455/423; 455/418; 455/422.1

(57) ABSTRACT

A System and method for ascertaining the state of a mobile communication apparatus. The state is ascertained by collecting data which can be allocated to individual components (C₁, C₂, C₃) and/or procedures (P₁, P₂, P₃) embedded within the mobile communication apparatus on the basis of status quo information deriving from the respective components (C₁, C₂, C₃) and/or procedures (P₁, P₂, P₃) and by radio transmitting the collected data from the mobile communication apparatus via the radio network to which the mobile communication apparatus is affiliated to a certain service center.

### CROSS-REFERENCE TO RELATED APPLICATION

This application claims priority of German Patent Application No. 102 49 700.1, which was filed on Oct. 25, 2003.

### TECHNICAL FIELD OF THE INVENTION

The invention relates to a method for ascertaining the state of a mobile communication apparatus by sending specific information from the mobile communication apparatus, as well as to an apparatus, especially a mobile phone, and a software implementation product having such functionality.

### BACKGROUND OF THE INVENTION

One of the most complex problems an operator running a mobile network is faced with concerns the collecting of feedback from mobile users when a mobile communication apparatus, such as a mobile phone, has a problem in the field.

Even this is a problem the manufacturers already face in the so called beta-test phase of a mobile communication apparatus, it is a major problem for a network operator. In particular with regard to mobile phones, it is often important to collect feedback about faulty user equipment in the fastest and most efficient way in order to react timely to any problem the user equipment has.

However, sometimes a problem, a mobile phone is faced with, is difficult to categorize or to determine, since the mobile user who experiences the problem does not have the technical knowledge to explain it correctly.

However, engineering tools implemented within the mobile communication apparatus, even if they comprise a trace program to collect data, usually are not available to the end user, since those engineering tools are also used for network operation and/or maintenance issues, such as to unlock locked mobiles for example. As a consequence, currently a faulty mobile communication apparatus usually has to be connected via a serial interface connection to a certain computer of a service station for retrieving debugging and system crash information in case of an unexpected condition.

Thus, due to the need of a physical connection, it is very difficult to debug mobiles already in the field. Moreover, sometimes it is not possible to get the necessary data at a later stage, as the fault is temporary and will be gone in a short time.

### SUMMARY OF THE INVENTION

An object of the invention is therefore to provide a new and improved approach to avoid above mentioned problems, to reduce the time necessary to ascertain the state of a mobile communication apparatus even in strange and seldom occurring network conditions and hence to significantly reduce the costs in comparison to the costs involved by recalling a mobile communication apparatus in the factory or service station.

Accordingly, the invention proposes to ascertain the state of a mobile communication apparatus, in particular of a mobile phone, by collecting within the mobile communication apparatus data which can be allocated to individual components and/or procedures embedded within said apparatus on the basis of status quo information deriving from the respective components and/or procedures and by radio transmitting the collected data from the apparatus via the radio network to which the apparatus is affiliated to a certain service center.

Thus, in particular by providing a mobile communication apparatus comprising means for collecting said data, means for processing collected data and means for radio transmitting said data from the mobile communication apparatus to at least one certain service center, it is enabled to directly send diagnostic and crash information collected within the mobile communication apparatus back, for example to a respective factory, the manufacturer or to the network operator, for enabling in most cases real-time debugging capabilities. As a further consequence faults, defects and/or malfunctions even in strange and seldom occurring network conditions will be rectified in a time and cost saving way in comparison to the current need for involving the mobile user, such as by recalling the mobile phone in the factory, even if the problem might not be repeatable there.

For ensuring an easier realization of the inventive approach, a trace routine or program is implemented within the apparatus to support the collection of the data. Moreover, it is proposed to use a standard trace routine to improve the inventive adaptation of mobile communication apparatuses already in the field and provided with a trace capability by the manufacturers.

The allocation of the collected data to the respective individual components and/or procedures, is preferably supported by means of a tagging incorporated within the data and assigned to the respectively component and/or procedure. This enables a very fast detection of the respective state of a component and/or procedure since the assigning of faults to a certain component and/or procedure is easily apparent and/or the learning of the respective characteristics and/or the internal relationships and links between different or several components and/or procedures is made possible.

According to a very preferred refinement it is proposed to code the collected data prior to the transmission of the data in a space-efficient format for limiting the bandwidth needed to transfer the data. Moreover, for transmitting the collected and/or coded data, preferably a Short Message Service, or SMS, and/or a predefined data call is established.

According to specific environment conditions it is further suggested that said collected may be stored within a buffer or storage associated to the processing means prior to transmit the data resulting in the advantage, that either at least a nearly real-time transmission, i.e., while the user is experiencing the misbehavior of the mobile, or a non-real-time transmission, i.e., the data are collected when the problem is occurred and sent to the service center at a later time, may be performed.

Moreover, even in case the mobile is shutting down as a result of an unexpected condition, data representing the mobile behavior and crash information describing the last actions of the mobile may be stored and hence, allowing a so-called post mortem debugging.

For the data transfer itself preferably one of the following refinements is used. At first it is proposed to transmit the data in regularly spaced time intervals, in particular for ensuring a continuous monitoring of the state of the mobile apparatus. In addition or as an alternative, the data transmission may be initiated by a specific menu procedure. The activation of such menu procedure is preferably performed automatically, for example caused by each log-in procedure of the mobile communication apparatus to the network to which the apparatus is affiliated and/or caused by each log-off procedure of the mobile communication apparatus.

According to a further embodiment, it is suggested that such initiating menu procedure can be additionally or alternatively activated by the user of the mobile communication apparatus and/or external via the network, such as caused by a corresponding request of the manufacturer directly to the mobile apparatus and/or caused by the network operator.

It is further advantageous to carry out a weighting of the collected data so that severe and less severe disturbances are easily detectable and/or distinguishable from one another, respectively, so that elimination measures can be correspondingly coordinated depending on the respective urgency.

It is further proposed that a processing of collected data and/or the transmitting is carried out dependent on selectable information items, in particular contained within the status quo information, especially to enable the user of the mobile apparatus and/or the network operator and/or the manufacturer to collect certain intended feedback resulting for example from a test phase or mode after debugging a component and/or procedure.

With regard to the preferred embodiment of mobile communication apparatus as being a mobile phone, it is further proposed to implement the inventive approach within a mobile phone and/or within a Subscriber Information Module, or SIM, card adapted to be used within the mobile phone designed to operate on a Global System for Mobile Communications, or GSM, standard and/or Universal Mobile Telecommunications System, or UMTS, standard, wherein the implementation of the inventive approach is preferably realized by the implementation of a corresponding software product. Such implementation may be performed during the manufacturing or during the initialization of the subscriber identity module or even external via the network, in particular in case the mobile phone is already in the field.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic diagram of an inventive mobile communication apparatus; and

FIG. 2 illustrates a schematic flow chart of an inventive basic procedure.

### DETAILED DESCRIPTION

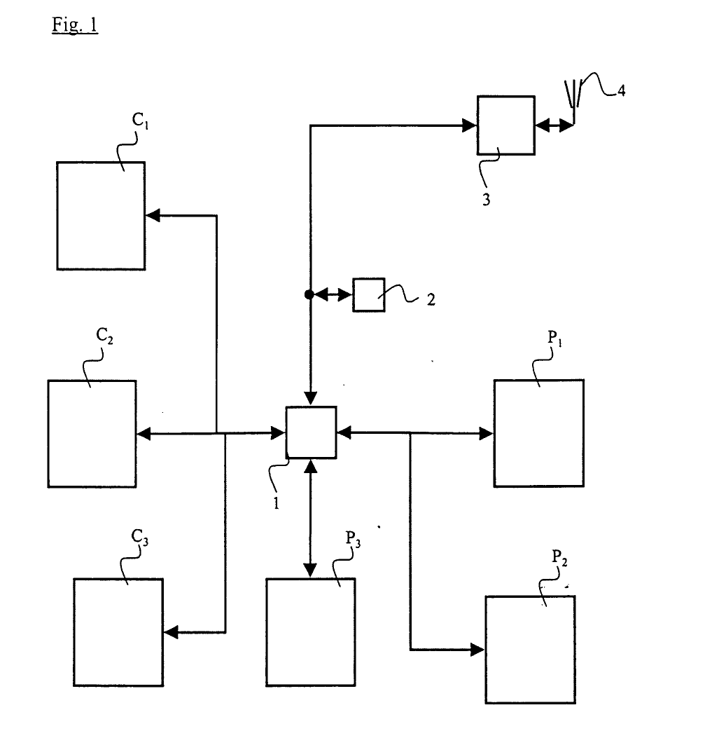

Regarding to FIG. 1, a schematic depiction of modules incorporated within a mobile communication apparatus that are affecting the inventive approach is shown.

In particular, a plurality of components C₁, C₂ and C₃ and a plurality of procedures P₁, P₂ and P₃ are embedded within the mobile communication apparatus, which is designed as a mobile phone and/or within a SIM-card for the insertion into the mobile phone, adapted to operate on a GSM-standard or UMTS-standard according to the preferred but exemplary embodiment forming the basis of the subsequent detailed description.

The respective components C₁, C₂ and C₃ may be a storage of the mobile phone, a phone book and for example an operation and/or service menu incorporating a plurality of operating functions structured in a defined order. The procedures P₁, P₂ and P₃ may be implemented software routines, such as for example for establishing a certain call, for encoding and/or decoding information into a certain format or respectively out of a certain transmission format, and for example an interactive routine for handling the operation menu or the phone book.

Each of these modules incorporated or embedded within the mobile phone is connected with a collecting unit 1, for collecting data deriving from the respective individual modules C₁, C₂, C₃, P₁, P₂ and P₃.

Practically, the collecting unit 1 is adapted to process the collected data in an application specific way to then forwarding the data to a transmit/receive unit 3 having the ability to also transmit/receive information or data to/from a certain service center. Between the collecting unit 1 and the transmit/receive unit 3, a certain buffer 2 or storage is incorporated. The transmit/receive unit 3 in turn is connected to an antenna means 4 for providing access to the air interface.

In substance, each of the modules and/or units depicted in FIG. 1 can be realized by hardware and/or by software, wherein the entire cooperation is controlled by a microprocessor and/or a correspondingly adapted software.

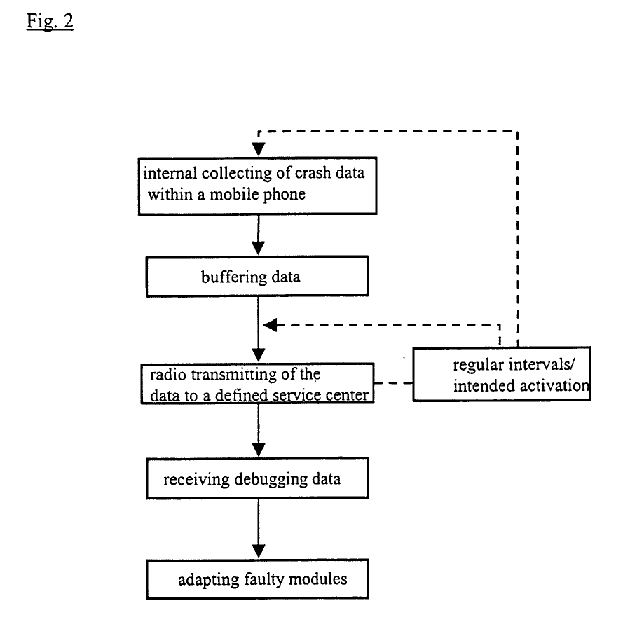

As can be seen from FIG. 1, the connection paths between the respective modules and/or units are designed to simultaneously or subsequently transmit data in the respective both directions. Accordingly as can be also seen from FIG. 2, when system crash, debugging and/or diagnostic information of the mobile phone were collected by the unit 1 and transmitted to the defined service center, possibly subsequent to a specific processing by the unit 1, to ascertain the state of the mobile phone, trouble specific debugging data might be sent back from the service center to the mobile phone, for example to further distribute such data to the respective erroneous or faulty modules C₁, C₂, C₃, P₁, P₂ and P₃ for their new adaptation or to directly implement new software or parts thereof in a respective module C₁, C₂, C₃, P₁, P₂ and P₃ which was affected by a detected fault.

As mentioned above, the collecting unit 1 is designed for processing the collected data in an application-specific way. For example, the collecting unit 1 may be adapted for coding the collected data in a space-efficient format prior to transmit the data via the air interface in order to limit the bandwidth needed to transfer the data. Accordingly, also a decoding functionality for received data may be comprised by the collecting unit 1.

It is mentioned however, that the invention even is comprising embodiments, wherein the processing of collected data and/or the transmission of data is carried out dependent on selectable information items, in particular contained within status quo information deriving from the respective module C₁, C₂, C₃, P₁, P₂ and/or P₃, especially to enable the user of the mobile apparatus, the network operator and/or the manufacturer to collect certain intended feedback resulting for example from a test phase or mode after debugging a component and/or procedure.

In practice, the processing functionality of the collecting means 1 may be additionally or alternatively designed for weighting the collected data prior to its transmission, so that severe and less severe disturbances are easily detectable and/or distinguishable from one another.

Moreover within the buffer 2, each of the data, which has to be transmitted or is received, may be stored, in particular to support an operation mode of sending crash and/or debugging information according to a non-continuously transmission procedure. Such a non-continuously transmission procedure is appreciated, since a continuously transmitting of the data, especially by using a so called SMS or a specific data channel or call would increase the needed energy and hence reduce the operating time of the mobile phone. Accordingly, one of the preferred non-continuously transmission procedures comprises the transmission of the data in regularly spaced time intervals.

By storing the data, it is further possible by the inventive approach to enable a so-called post mortem debugging.

Depending on the specific mobile phone used however, the collecting but especially the transmission of the data may be performed additionally or alternatively by initiating a specific procedure, as indicated in FIG. 2 by the dotted lines.

This can be activated for example by pressing a certain key of the keyboard of the mobile phone or by means of speech control. Furthermore it is possible to activate the step of transmitting the collected and/or processed data when the mobile phone is logged-in the network to which the mobile phone is affiliated and/or when the mobile phone is logged-off said network.

Consequently the inventive approach of transferring the data comprising diagnostic and/or crash information of individual modules implemented in the mobile phone to a preferably predefined destination using a short message service (SMS) or a data call may be initiated by the mobile phone either online and/or in real-time, i.e., while the user is experiencing the misbehavior of at least one module, or in non-real-time, i.e., the data are collected when the problem is occurring and sent to the destination such as the network operator or the manufacturer at a later time.

Although the usage of the SMS merely allows a limit amount of data to be transferred, substantially such SMS is enough to transfer at least the last seconds of operations of the mobile phone before crashing on-an unexpected condition.

The collecting means 1 may be realized by a trace module or program so that the data collected by the mobile are traces describing the mobile behavior and crash information describing the last actions performed by the mobile before for example shutting down as result of the unexpected condition and hence allowing a so called post mortem debugging.

Thus, based on the above mentioned, the sending of these traces or data may be further initiated by the user for example by providing a specific setting dialogue in the user interface, comprising for example selectable comments such as “start log-in,” “start log-off,” “send data,” “send crash-data” and “send diagnostic data.” On the other hand side these transmissions also may be initiated by the network operator or the manufactory requesting crash or debugging information directly to the mobile phone.

In this case, the initiating mechanism is also known to these destinations and the mobile is able to recognize a particular type of incoming signals or SMS containing the comments for the mobile.

As a consequence, the data transferred between the mobile phone and the network comprising the system crash, diagnostic information and/or between the network and the mobile phone comprising debugging data may be transferred without signaling it to the user of the mobile phone. Thus the feedback about faulty mobile phones may be collected also in the field in the fastest and most efficient way to react timely to any problem the phone has, substantially without annoying the user who is already upset because his mobile does not work as he expects.

Furthermore, the more complex the internal arranged or implemented modules C₁, C₂, C₃, P₁, P₂ and/or P₃ of a mobile phone is, the more difficult will become the detection of the respective current state of the mobile phone or of the respective modules. Based thereon preferred embodiments, in particular by implementing the respective designed software, comprise a weighting functionality so that the detected disturbances or faults may be pre-ordered according to seriousness or non-seriousness.

Correspondingly, for easy finding the causal fault sources and/or for offering a learning possibility of logical and/or physical link structures within a module or between different modules the collected data are allocated by means of a tagging incorporated within the data and assigned to the respective components C₁, C₂, and/or C₃ and/or procedures P₁, P₂ and/or P₃.

As a consequence of the inventive approach, almost real-time debugging capabilities are guarantied, when the user or the mobile phone calls the service center since the support devices and/or persons can collect technical data immediately. Moreover, sine the inventive approach enables the possibility to collect crash and/or debugging information even in strange and seldom occurring network condition even test procedures may be performed by the service center without annoying the user.

Although the present invention has been described in detail, those skilled in the art should understand that they can make various changes, substitutions and alterations herein without departing from the spirit and scope of the invention in its broadest form.

What is claimed is:

1. A method of ascertaining a state of a mobile communication apparatus, comprising:
collecting data on at least one of individual components and procedures embedded within said mobile communication apparatus based on status quo information derived therefrom; and
radio transmitting said data from said mobile communication apparatus via said radio network to which said mobile communication apparatus is affiliated to a service center.

2. The method as recited in claim 1 wherein said collecting is performed by using a trace routine.

3. The method as recited in claim 1 wherein said transmitting is performed by using a selected one of an SMS and a predefined data call.

4. The method as recited in claim 1 wherein said data are coded in a space-efficient format prior to performing said radio transmitting.

5. The method as recited in claim 1 wherein said data are stored prior to performing said radio transmitting.

6. The method as recited in claim 1 wherein said radio transmitting is performed in regularly spaced intervals.

7. The method as recited in claim 1 wherein said radio transmitting is performed during an initializing menu procedure.

8. The method as recited in claim 7 wherein said menu procedure is activated during a selected one of when said mobile communication apparatus is logged-in to said network and when said mobile communication apparatus is logged-off from said network.

9. The method as recited in claim 7 wherein said menu procedure is activated by a selected one of said user of said mobile communication apparatus and externally via said network.

10. The method as recited in claim 1 wherein said data are transferred between said mobile communication apparatus and said network without signaling said user of said mobile communication apparatus.

11. The method as recited in claim 1 wherein said data are weighted.

12. The method as recited in claim 1 wherein a selected one of said collecting and said transmitting is carried out dependent on selectable information items.

13. A mobile communication apparatus, comprising:
means for collecting data on at least one of individual components and procedures embedded within said mobile communication apparatus based on status quo information derived therefrom; and
means for radio transmitting said data from said mobile communication apparatus via said radio network to which said mobile communication apparatus is affiliated to a service center.

14. The mobile communication apparatus as recited in claim 13 wherein said means for collecting is a trace routine.

15. The mobile communication apparatus as recited in claim 13 wherein said means for transmitting is a selected one of an SMS and a predefined data call.

16. The mobile communication apparatus as recited in claim 13 wherein said data are coded in a space-efficient format prior to said radio transmitting.

17. The mobile communication apparatus as recited in claim 13 wherein said data are stored prior to said radio transmitting.

18. The mobile communication apparatus as recited in claim 13 wherein said radio transmitting is performed in regularly spaced intervals.

19. The mobile communication apparatus as recited in claim 13 wherein said radio transmitting is performed during an initializing menu procedure.

20. The mobile communication apparatus as recited in claim 19 wherein said menu procedure is activated during a selected one of when said mobile communication apparatus is logged-in to said network and when said mobile communication apparatus is logged-off from said network.

21. The mobile communication apparatus as recited in claim 19 wherein said menu procedure is activated by a selected one of said user of said mobile communication apparatus and externally via said network.

22. The mobile communication apparatus as recited in claim 13 wherein said data are transferred between said mobile communication apparatus and said network without signaling said user of said mobile communication apparatus.

23. The mobile communication apparatus as recited in claim 13 wherein said data are weighted.

24. The mobile communication apparatus as recited in claim 13 wherein a selected one of said collecting and said transmitting is carried out dependent on selectable information items.

25. The mobile communication apparatus as recited in claim 13 wherein said mobile communication apparatus is a mobile phone adapted to operate on a selected one of a GSM standard and a UMTS-standard.
